(19) United States
(12) Patent Application Publication
(10) Pub. No.: US 2022/0184840 A1
(43) Pub. Date: Jun. 16, 2022

(54) SLICING AND PACKAGING ASSEMBLY WITH MODIFIED ATMOSPHERE

(71) Applicant: Provisur Technologies, Inc., Chicago, IL (US)

(72) Inventors: Richard J. Dahlman, JR., Mokena, IL (US); Glen F. Pryor, Manhattan, IL (US); Lowell W. Sampson, St. George, UT (US)

(21) Appl. No.: 17/643,479

(22) Filed: Dec. 9, 2021

Related U.S. Application Data
(60) Provisional application No. 63/126,114, filed on Dec. 16, 2020.

(51) Int. Cl. B26D 7/27; B65B 55/00; B65B 25/06; A23B 4/12; A23B 4/015; A23B 4/16; A23B 4/30; A23L 3/3589; A23L 3/3418; A23L 3/28; A23L 3/00; A23C 19/097; A23C 19/10; A01J 27/00

(52) U.S. Cl. CPC B26D 7/27; B26D 2007/0025; B65B 25/067; B65B 25/068; A23B 4/12; A23B 4/015; A23B 4/16; A23B 4/30; A23L 3/3589; A23L 3/3418; A23L 3/28; A23L 3/001; A23C 19/0973; A23C 19/105; A01J 27/00; A23V 2002/00; B26D 2210/02; B65B 55/00

(57) ABSTRACT

An assembly is provided for turning a food product into slices of food product. The assembly includes a microbial treatment assembly configured to move the food product along a path, and a microbial intervention apparatus configured to substantially reduce an amount of microbes on an exterior surface of the food product while the food product is traveling along the path, a slicing machine downstream of the microbial treatment assembly, the slicing machine being configured to slice the food product into slices, an enclosure in which the slicing machine is positioned, the enclosure being sealed from outside atmosphere, and a microbial treatment apparatus in communication with the enclosure and configured to deter the growth of microbes on the food product.

### CROSS-REFERENCE TO RELATED APPLICATION(S)

This application claims priority to U.S. provisional application Ser. No. 63/126,114, filed on Dec. 16, 2020, the contents of which are incorporated herein in its entirety.

### FIELD OF THE DISCLOSURE

The present disclosure relates to an assembly for the treatment and slicing of food product in a modified atmosphere environment.

### BACKGROUND

It is desirable to treat meat products to deter growth of microbes. Various treatments are known. One example is provided in U.S. Pat. No. 10,874,113 which uses a combination of high-pressure processing and a bacteria reducing chemical on ground meat. Another example is provided in U.S. Publication No. 2020/0337341 which uses a combination of a high pH composition and an oxidizer.

### SUMMARY

An assembly is provided for turning a food product into slices of food product. The assembly includes a microbial treatment assembly configured to move the food product along a path, and a microbial intervention apparatus configured to substantially reduce an amount of microbes on an exterior surface of the food product while the food product is traveling along the path, a slicing machine downstream of the microbial treatment assembly, the slicing machine being configured to slice the food product into slices, an enclosure in which the slicing machine is positioned, the enclosure being sealed from outside atmosphere, and a microbial treatment apparatus in communication with the enclosure and configured to deter the growth of microbes on the food product.

### BRIEF DESCRIPTION OF THE DRAWINGS

The organization and manner of the structure and operation of the disclosed embodiments, together with further objects and advantages thereof, may best be understood by reference to the following description, taken in connection with the accompanying drawings, which are not necessarily drawn to scale, wherein like reference numerals identify like elements in which:

FIG. 1 depicts a cross-sectional view of an assembly for the treatment and slicing of food product into slices;

FIG. 2 depicts a top plan view of the assembly;

FIG. 3 depicts a side elevation view of a microbial treatment assembly of the assembly;

FIG. 4 depicts a perspective view of an entrance product interlock of the assembly shown in cross-section;

FIG. 5 depicts a side elevation view of a peeling machine of the assembly;

FIGS. 6A-6C depict perspective views of a portion of the peeling machine of FIG. 5 and a food product being cut;

FIGS. 7 and 8 depict perspective views of a slicing machine of the assembly;

FIG. 9 depicts a side elevation view of a packaging machine of the assembly;

FIG. 10 depicts a perspective view of an exit product interlock of the assembly; and

FIG. 11 depicts a block diagram of a control system of the assembly.

### DETAILED DESCRIPTION

While the disclosure may be susceptible to embodiment in different forms, there is shown in the drawings, and herein will be described in detail, specific embodiments with the understanding that the present disclosure is to be considered an exemplification of the principles of the disclosure, and is not intended to limit the disclosure to that as illustrated and described herein. Therefore, unless otherwise noted, features disclosed herein may be combined together to form additional combinations that were not otherwise shown for purposes of brevity. It will be further appreciated that in some embodiments, one or more elements illustrated by way of example in a drawing(s) may be eliminated and/or substituted with alternative elements within the scope of the disclosure.

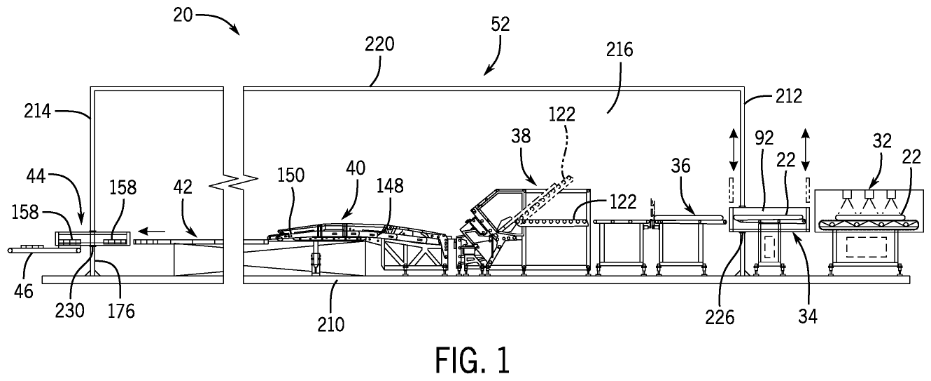

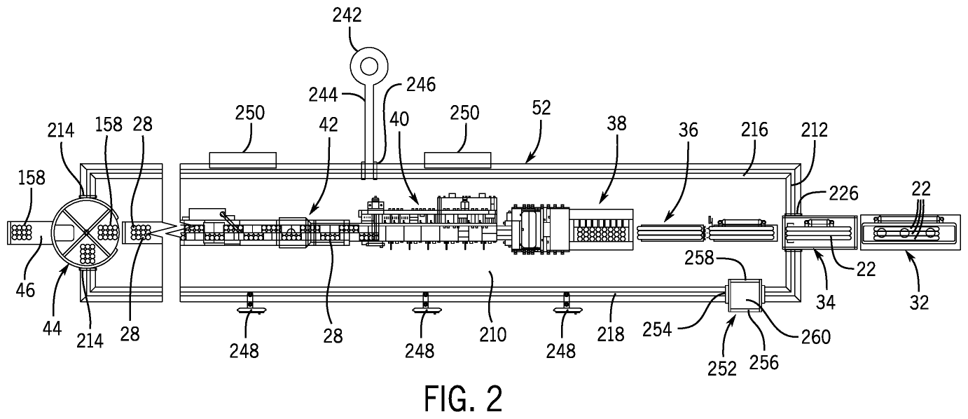

FIGS. 1 and 2 show an overview of an assembly 20 for the treatment of encased loaves of food product 22, the peeling of a casing 26 from a food product 24 in the loaf of food product 22, the slicing of the food product 24 into slices 28, and the packaging of the slices 28. In some embodiments, the food product 24 is whole muscle or whole trimmings of animal meat, such as beef, lamb, turkey, pork, or poultry. In some embodiments, the food product 24 is cheese. While the present disclosure specially relates to encased loaves of food product, non-encased food product may also be processed by the assembly 20 and the peeling omitted.

The assembly 20 includes a microbial treatment assembly 32, an entrance product interlock 34 downstream of the microbial treatment assembly 32, a peeling machine 36 downstream of the entrance product interlock 34, a slicing machine 38 downstream of the peeling machine 36, a loading assembly 40 downstream of the slicing machine 38, a packaging machine 42 downstream of the loading assembly 40, an exit product interlock 44 downstream of the packaging machine 42, and an output conveyor 46 downstream of the exit product interlock 44. In an embodiment, the microbial treatment assembly 32, the entrance product interlock 34, the peeling machine 36, the slicing machine 38, the loading assembly 40, the packaging machine 42, the exit product interlock 44 are in-line with each other.

The peeling machine 36, the slicing machine 38, the loading assembly 40, and the packaging machine 42 are provided within an enclosure 52 which is sealed from atmosphere outside of enclosure 52. The entrance product interlock 34 provides a means for the food product 22 to enter into the enclosure 52 after being treated by the microbial treatment assembly 32. The exit product interlock 44 provides a means for the packaged slices 28 to exit from the enclosure 52.

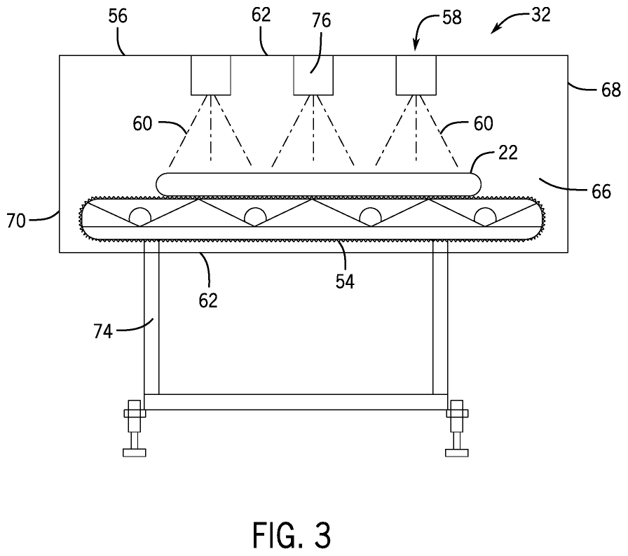

In an embodiment, the microbial treatment assembly 32, see FIG. 3, includes an endless conveyor belt 54 positioned within a housing 56 and a microbial intervention apparatus 58. The conveyor belt 54 causes the food product 22 to travel along a path. The microbial intervention apparatus 58 causes antimicrobial agent 60 to come into contact with an exterior surface of the food product 22 which substantially reduces an amount of microbes on the exterior surface of the food product 22 prior to entrance into the enclosure 52. The housing 56 has a top wall 62, a bottom wall 64, and opposite side walls 66 (only one of which is shown) therein that is used to transport the food product 22 through the housing 56. An entrance end 68 of the housing 56 is open and an exit end 70 of the housing 56 is open.

In an embodiment, the antimicrobial agent 60 of the microbial intervention apparatus 58 is an antimicrobial solution which is deposited onto the exterior surface of the food product 22 as the food product 22 travels along the conveyor belt 54 through the housing 56. In an embodiment, the microbial intervention apparatus 58 includes at least one sprayer 76 within the housing 56 which dispenses the antimicrobial solution onto the exterior surface of the food product 22. In an embodiment, the sprayers 76 are located on an upper internal surface of the top wall 62 of the housing 56. In another embodiment, the antimicrobial agent 60 of the microbial intervention apparatus 58 is provided by the housing 56 being filled with antimicrobial solution within a cavity formed by the bottom wall 64 through which the food product 22 passes and may be completely submerged, such that the food product 22 passes through a bath of the antimicrobial agent 60. The housing 56 has suitable fill ports and drain ports to provide for the antimicrobial agent 60 to be pumped into and removed from the housing 56. Suitable antimicrobial solutions include, but are not limited to, alcohols and organic acids such as lactic acid, citric, acetic, peroxyacetic. In yet another embodiment, the antimicrobial agent 60 of the microbial intervention apparatus 58 is light, such as ultraviolet light, emitted from illuminations devices 76 which irradiate the exterior surface of food product 22. Other means for substantially reducing the amount of microbes on the exterior surface of the food product 22 are known and are within the scope of the present disclosure. In other embodiments, combinations of sprayers, illuminations devices, etc., can be included in the microbial intervention apparatus 58.

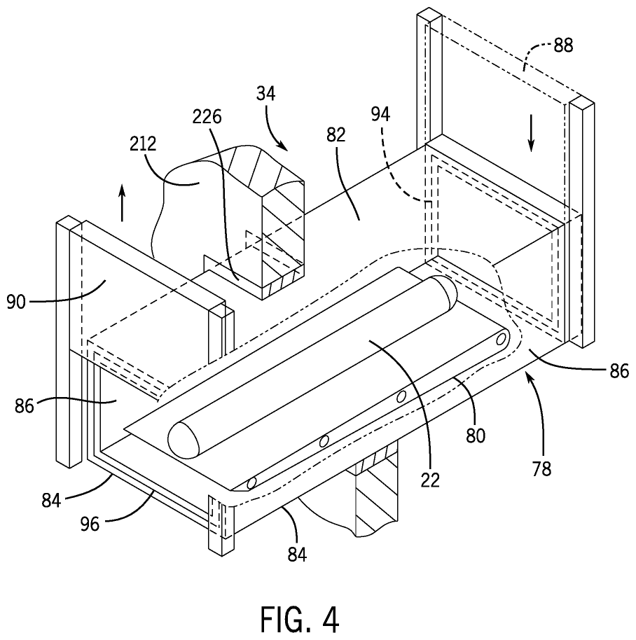

The entrance product interlock 34, see FIG. 4, provides a means for the food product 22 to enter into the enclosure 52 after being treated by the microbial treatment assembly 32 without allowing a significant amount of atmosphere outside of the enclosure 52 into the enclosure 52. In an embodiment, the entrance product interlock 34 includes a housing 78 and an endless conveyor belt 80 within the housing 78. The housing 78 includes a top wall 82, a bottom wall 84 and side walls 86 extending longitudinally between the top and bottom walls 82, 84. Opposite loading and unloading ends of the walls 82, 84, 86 are open. The housing 78 further includes a movable entrance door 88 at the loading end which can be moved upward into an open position to open the loading end and can be moved downward into a closed position to close the loading end, and a movable exit door 90 mounted at the unloading end which can be moved upward into an open position to open the unloading end and can be moved downward into a closed position to close the unloading end. When both doors 88, 90 are in the closed position, a cavity 92 is formed by the housing 78. A seal 94 is provided between the walls 82, 84, 86 and the entrance door 88, and a seal 96 is provided between the walls 82, 84, 86 and the exit door 90 so that the cavity 92 is sealed from the atmosphere outside of the enclosure 52 and from the atmosphere within the enclosure 52 when the doors 88, 90 are closed. In use, only one of the doors 88, 90 is open at a time as described herein. The seals 94, 96 may be formed of an elastomeric material, such as urethane.

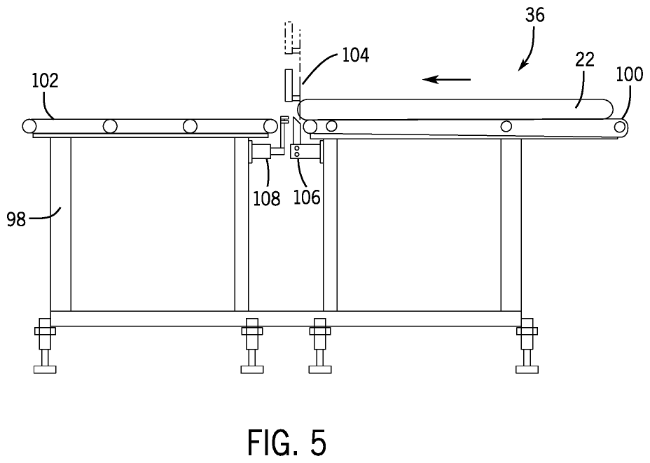

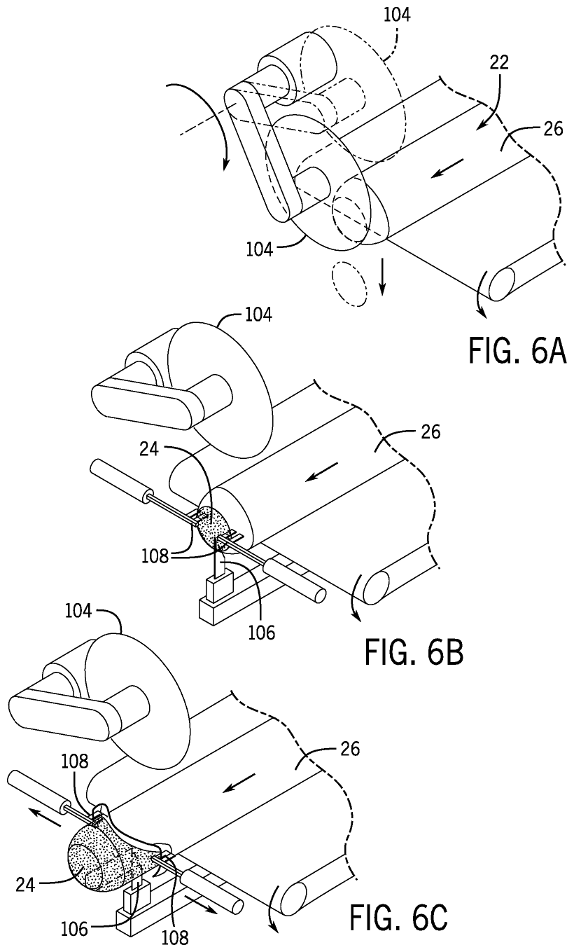

The peeling machine 36, see FIGS. 5-6C, peels the casing 26 from the food product 24. The peeling machine 36 can be of a type which is a commercially available Log Peeler. In an embodiment, the peeling machine 36 includes a frame 98 on which endless conveyor belts 100, 102 are provided. The conveyor belt 100 receives the food product 22 from the entrance product interlock 34. A first cutter 104 is attached to the frame 98 and cuts a front end of the food product 22. This exposes the food product 24 to the atmosphere within the enclosure 52. After the first cutter 104 is disengaged, a second cutter 106, which is attached to the frame 98, engages the food product 22 and causes a longitudinal cut to be formed in the casing 26 as the food product 22 is conveyed along the length of the conveyor belts 100, 102, and grippers 108, which are attached to the frame 98, grasp front ends of the casing 26 and peel the casing 26 away from the food product 24 as the food product 22 is transported by the conveyor belts 100, 102. This completely exposes the food product 24 to the atmosphere within the enclosure 52.

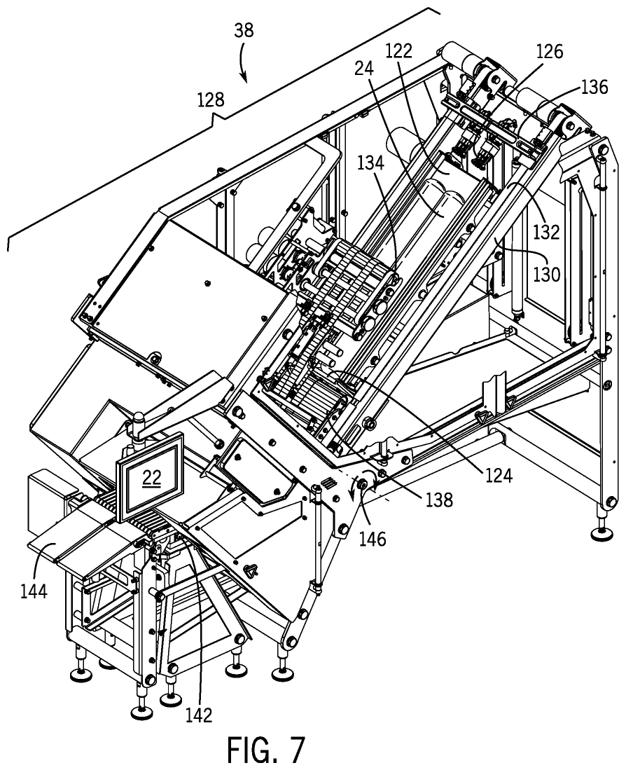

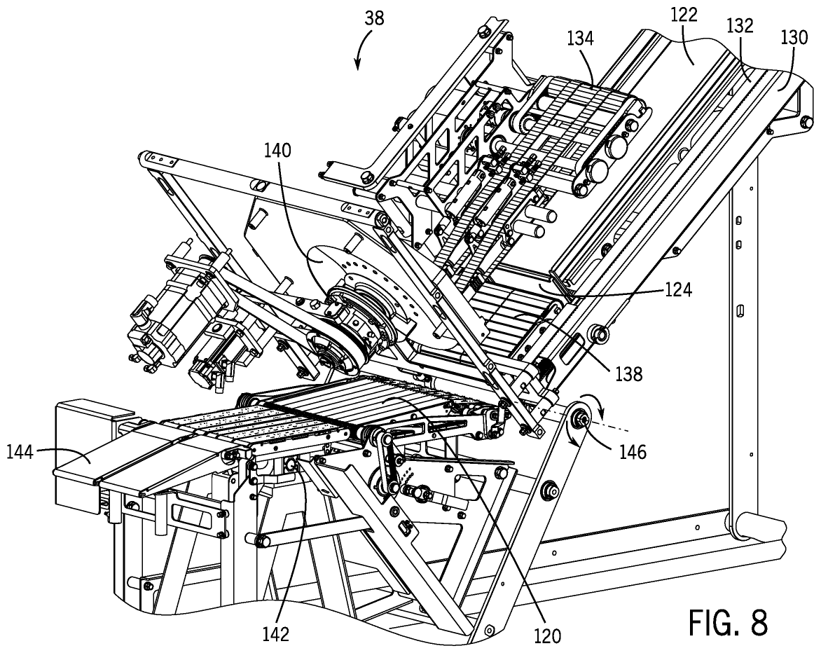

The slicing machine 38 cuts slices 28 from the food product 24 and deposits the slices 28 on an output conveyor assembly 120, forming shingled or stacked slices 28. The slices 28 can be piles, bunches or groups of thin sliced product. The slicing machine 38 can be of a type as described in U.S. Pat. No. 10,160,602, herein incorporated by reference, however, it is to be understood that numerous other slicing machines can be used in the present assembly. An example slicing machine 38 is shown in FIGS. 7 and 8 and includes a product tray 122, a gate 124, a gripping device 126, an upper exterior frame 128, a product tray lift 130, a belt 132, an upper in-feed 134, a bracket 136, a lower in-feed 138, a slicing device 140, the output conveyor assembly 120, a load cell 142, and a classifier device 144.

The product tray lift 130 is adapted to rotate around a pivot point 146 in order to raise and lower the product tray 122. Initially, the food product 24 is loaded in the product tray 122 while the product tray lift 130 has the product tray 122 disposed in a horizontal position with the gate 124 holding the food product 24 in the product tray 122 by engaging a front end of the food product 24. After the food product 24 is loaded in the product tray 122, the product tray lift 130 is rotated around the pivot point 146 to lift the product tray 122. Next, the gripping device 126 is moved to engage against an end of the food product 24 by rotating the belt 132, which in turn moves the bracket 136 attached to the belt 132, which in turn moves the gripping device 126 attached to the bracket 136. After the gripping device 126 contacts the end of the food product 24, the gripping device 126 closes to grip the rear end of the food product 24. The gate 124 is then moved away from the front end of the food product 24 so that the gate 124 no longer blocks the food product 24 from moving out of the product tray 122. Next, the upper and lower in-feeds 134. 138 are rotated, while the gripping device 126 is moved to cause the food product 24 to move toward the slicing device 140. The slicing device 140 slices the food product 24 into slices 28 which then falls onto the output conveyor assembly 120 which is located directly underneath the slicing device 140. The output conveyor assembly 120 moves the slices 28 onto a portion of the output conveyor assembly 120 which has the load cell 142. The load cell 142 weighs the slices 28, and then the output conveyor assembly 120 moves the weighed slices 28 onto the classifier device 144. The classifier device 144 classifies the weighed slices 28 as is known in the art.

The loading assembly 40, see FIGS. 1 and 2, receives the slices 28 from the slicing machine 38 and arranges the slices 28 into rows. The loading assembly 40 can be of a type described U.S. Pat. No. 7,065,936, herein incorporated by reference, however, it is to be understood that numerous other loading machines can be used in the present assembly. The loading assembly 40 includes a conveyor assembly 148 which may include a check weight conveyor, wherein unacceptable slices 28 can be rejected and diverted. Acceptable slices 28 are moved from the conveyor assembly 148 onto a staging conveyor 150 that may include a row staging conveyor wherein a single file stream of slices 28 is rearranged in laterally extending rows. Such a staging conveyor is described in U.S. Pat. No. 5,810,149, which is herein incorporated by reference. The staging conveyor 150 delivers the rows of slices 28 to the packaging machine 42.

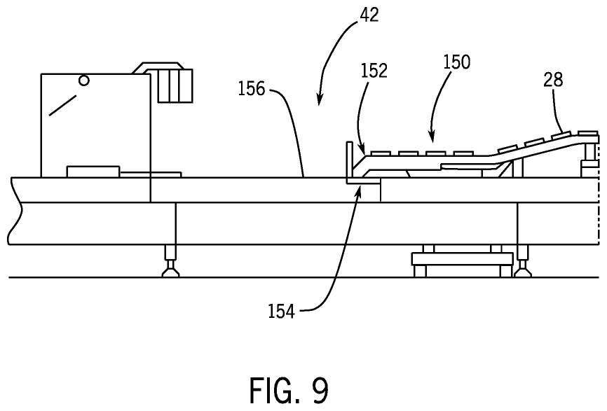

An example packaging machine 42 is shown in FIG. 9. The packaging machine 42 receives the slices 28 from the loading assembly 40, and packages the slices 28 into packaging. The packaging machine 42 can be of a type described U.S. Pat. No. 7,065,936, herein incorporated by reference, however, it is to be understood that numerous other packaging machines can be used in the present assembly. At a fill machine 152, the staging conveyor 150 delivers rows of slices 28 into containers in the form of a group of rows of pockets 154 formed in a lower web of film 156 by the packaging machine 42. Downstream of the fill machine 152, the pockets 154, filled with slices 28, are sealed by an upper web of film to form a package 158. The slices 28 are then sealed within the package 158 such that the slices 28 are not subject to atmosphere.

The exit product interlock 44 receives the packages 158 from the packaging machine 42. In an embodiment, the exit product interlock 44 includes a housing 160 formed of a top wall 162, a bottom wall 164, and a side wall 166 extending between the top and bottom walls 162, 164. A plurality of partition walls 168 extend between the walls 162, 164, 166 to form separate spaces 170. As shown, four spaces 170 are provided. A movable door 172 is mounted on the side wall 166 proximate to each space 170 which can be moved upward to an open position to open each space 170, and can be moved downward to a closed position to close each space 170. A movable door 174 is mounted on the bottom wall 164 proximate to each space 170 which can be moved outward to an open position to open each space 170 and can be moved inward to a closed position to close each space 170. The housing 160 is rotatably mounted on a frame 176 so that the housing 160 can be rotated relative to the enclosure 52. Each space 170 can be indexed to be within the enclosure 52 and each space 170 can be indexed to be outside of the enclosure 52 upon rotation of the housing 160.

The output conveyor 46 has an input end positioned underneath the bottom wall 164 of the exit product interlock 44 and receives the packages 158 from the exit product interlock 44 when each space 170 can be indexed to be outside of the enclosure 52 and the door 174 is opened.

In operation, an operator loads food product 22 through the entrance end 68 of the housing 56, and onto the conveyor belt 54 of the microbial treatment assembly 32. As the conveyor belt 54 moves, the microbial intervention apparatus 58 is activated to treat the food product 22 and reduce the amount of microbes on the exterior surface of the food product 22. As the food product 22 move out of the exit end 70 of the housing 56, the entrance door 90 of the entrance product interlock 34 is moved to the open position, and the treated food product 22 passes through the open loading end of the housing 78 and onto the conveyor belt 80. The exit door 90 is in the closed position at this point. After the food product 22 passes through the loading end of the entrance product interlock 34, the entrance door 88 is moved to the closed position. Thereafter, the exit door 90 is moved to the open position and the conveyor belt 80 is moves the food product 22 through the unloading end. The food product 22 then passes onto the conveyor belt 100 of the peeling machine 36. The first cutter 104 is engaged with the food product 22 to cut the front end off of the food product 22 and then disengaged from the food product 22. The second cutter 106 and the grippers 108 are engaged with the food product 22 to form the longitudinal cut in the casing 26 and peel the casing 26 away from the food product 24 as the food product 22 is transported by the conveyor belts 100, 102. The food product 24 then exits the peeling machine 36 through the unloading end upon further movement of the conveyor belts 100, 102 and onto the product tray 122 of the slicing machine 38. The product tray 122 is lifted, the food product 24 gripped by the grippers 118, and the gate 124 is lowered. Next, the food product 24 is sliced by the slicing device 140 to form the slices 28 which fall onto the output conveyor assembly 120 and are transported to the packaging machine 42. The packaging machine 42 receives the slices 28, and packages the slices 28 into the packages 158 and transports the packages 158 to the exit product interlock 44. One of the movable doors 172 of the exit product interlock 44 is moved to the open position and the package 158 passes therethrough into the space 170, and seats on top of the door 174. The movable door 172 is then moved to the closed position, and the exit product interlock 44 is rotated to receive the next package 158 in the next space 170 in the same manner. When the exit product interlock 44 is rotated such that the space 170 having the package 158 is aligned with the output conveyor 46, that door 174 is moved to the open position and the package 158 passes therethrough and drops onto the output conveyor 46.

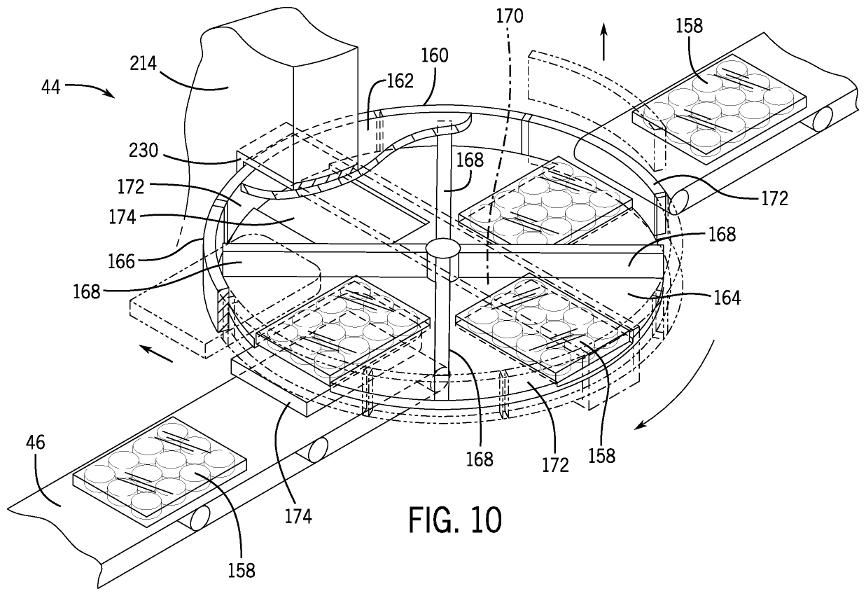

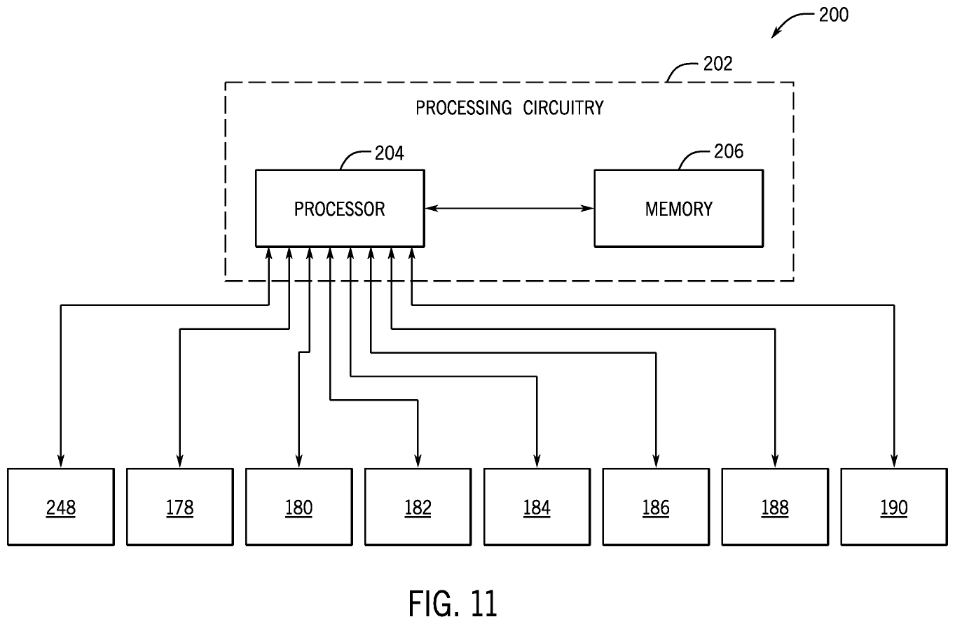

The assembly 20 is automated such that no action by the operator is required after the food product 22 are loaded into the microbial treatment assembly 32. The components of the microbial treatment assembly 32 are actuated by a driving assembly 178 which may be positioned within a frame which supports the housing 56. The components of the entrance product interlock 34 are actuated by a driving assembly 180 which may be positioned within a frame which supports the housing 78. The components of the slicing machine 38 are actuated by a driving assembly 182 which may be positioned within a frame which supports the product tray 122 and the slicing device 140. The components of the loading assembly 40 are actuated by a driving assembly 184 which may be positioned within a frame which supports the conveyor assembly 148. The components of the packaging machine 42 are actuated by a driving assembly 186 which may be positioned within a frame which supports the fill machine 152 and the staging conveyor 150. The components of the exit product interlock 44 are actuated by a driving assembly 188 which may be positioned within a frame which supports the housing 160. The components of the output conveyor 46 are actuated by a driving assembly 190 which may be positioned within a frame which supports the output conveyor 46. Each driving assembly 178, 180, 182, 184, 186, 188, 190 is in communication with a control system 200 which controls the automatic operation of the assembly 20 which is illustrated in block diagram in FIG. 10.

The operation of the assembly 20 is controlled by the control system 200. In this regard, when implemented on the assembly 20, the control system 200 energizes and controls operation of the moving components of the assembly 20. It will be appreciated that the components, devices or elements illustrated in and described with respect to FIG. 10 below may not be mandatory and thus some may be omitted in certain embodiments. Additionally, some embodiments may include further or different components, devices or elements beyond those illustrated in and described with respect to FIG. 10.

In some example embodiments, the control system 200 may include processing circuitry 202 that is configurable to perform actions in accordance with one or more example embodiments disclosed herein. In this regard, the processing circuitry 202 may be configured to perform and/or control performance of one or more functionalities of the assembly 20, in accordance with various example embodiments. The processing circuitry 202 may be configured to perform data processing, application execution and/or other processing and management services according to one or more example embodiments. In embodiments in which the driven components include an on-board motor controller, the processing circuitry 202 may comprise the on-board motor controller(s) and/or may be communicatively coupled with the on-board motor controller(s) to enable the processing circuitry 202 to communicate with and control operation of the assembly 20, in accordance with various example embodiments.

In some embodiments, the control system 200 or a portion(s) or component(s) thereof, such as the processing circuitry 202, may include one or more chipsets and/or other components that may be provided by integrated circuits.

In some example embodiments, the processing circuitry 202 may include a processor 204 and, in some embodiments, such as that illustrated in FIG. 10, may further include memory 206. The processor 204 may be embodied in a variety of forms. For example, the processor 204 may be embodied as various hardware-based processing means such as a microprocessor, a coprocessor, a controller or various other computing or processing devices including integrated circuits such as, for example, an ASIC (application specific integrated circuit), an FPGA (field programmable gate array), some combination thereof, or the like. Although illustrated as a single processor, it will be appreciated that the processor 204 may comprise a plurality of processors. The plurality of processors may be in operative communication with each other and may be collectively configured to perform one or more functionalities of the assembly 20 as described herein. For example, in some embodiments in which the processor 204 comprises a plurality of processors, the plurality of processors may comprise one or more on-board motor controllers. In some example embodiments, the processor 204 may be configured to execute instructions that may be stored in the memory 206 or that may be otherwise accessible to the processor 204. As such, whether configured by hardware or by a combination of hardware and software, the processor 204 is capable of performing operations according to various embodiments while configured accordingly. In some example embodiments, the memory 206 may include one or more memory devices. Memory 206 may include fixed and/or removable memory devices. In some embodiments, the memory 206 may provide a non-transitory, computer-readable storage medium that may store computer program instructions that may be executed by the processor 204. In this regard, the memory 206 may be configured to store information, data, applications, instructions and/or the like for enabling the assembly 20 to carry out various functions in accordance with one or more example embodiments.

The processor 204 is in communication with one or more of the driving assemblies 178, 180, 182, 184, 186, 188, 190 for causing actuation of the components of the microbial treatment assembly 32, of the entrance product interlock 34, of the peeling machine 36, of the slicing machine 38, of the loading assembly 40, of the packaging machine 42, of the loading assembly 40, of the exit product interlock 44, and of the output conveyor 46. The driving assemblies 178, 180, 182, 184, 186, 188, 190 may be embodied as various means, such as circuitry, hardware, a computer program product comprising a computer readable medium (for example, the memory 206) storing computer readable program instructions that are executable by a processing device (for example, the processor 204), or some combination thereof. In some embodiments, the processor 204 (or the processing circuitry 202) may include, or otherwise control the driving assemblies 178, 180, 182, 184, 186, 188, 190.

The peeling machine 36, the slicing machine 38, the loading assembly 40, and the packaging machine 42 are provided within the enclosure 52 which is sealed from outside atmosphere. The enclosure 52 includes a floor 210, an entrance wall 212 extending upward from the floor 210, an exit wall 214 extending upward from the floor 210, side walls 216, 218 extending upward from the floor 210, and a top wall 220 closing upper ends of the walls 212, 214, 216, 218, 220. The walls 212, 214, 216, 218, 220 are mated together to define a cavity 222 therein in which the peeling machine 36, the slicing machine 38, the loading assembly 40 and the packaging machine 42 are positioned and rest on the floor 210. The cavity 222 is sealed from the entrance of outside atmosphere.

The housing 78 of the entrance product interlock 34 is positioned within an opening 224 through the entrance wall 212 of the enclosure 52 and is sealed to the entrance wall 212 by a seal 226. The seal 226 prevents the entrance of outside atmosphere into the enclosure 52 through the joint between the housing 78 and the entrance wall 212. Likewise, the housing 160 of the exit product interlock 44 is positioned within an opening 228 through the exit wall 214 of the enclosure 52 and is sealed to the exit wall 214 by a seal 230. This seal 230 allows the rotation of the housing 160 of the exit product interlock 44 relative to the exit wall 214, while preventing the entrance of outside atmosphere into the enclosure 52 through the joint between the housing 160 and the exit wall 214. The seals 226, 230 may be formed of an elastomeric material, such as urethane.

The enclosure 52 has a microbial treatment apparatus 240 which deters the growth of microbes on the food product 24 by modifying the atmosphere within the cavity 222 through which the food product 24 travels as the food product 24 is being processed by the peeling machine 36, the slicing machine 38, the loading assembly 40 and the packaging machine 42. In an embodiment, the microbial treatment apparatus 240 is provided by one or more pumps 242 connected to the cavity 222 formed by the enclosure 52 by one or more pipes 244. The pipe 244 passes through one of the walls (shown as wall 216 in FIG. 2) and is sealed to the wall 216 by a seal 246. The seal 246 may be formed of an elastomeric material, such as urethane. Alternatively, instead of providing a separate seal 246, the components can be welded together to prevent the entrance of atmosphere at the joint.

In an embodiment, the oxygen is removed from the cavity 222 by the one or more pumps 242, and another gas or gas mixture is injected into the cavity 222 by the one or more pumps 242. The injected gas or gas mixture promotes the shelf life of the slices 28. An example of a suitable gas or gas mixtures is a non-oxygen gas, for example, carbon dioxide gas, nitrogen gas, a reduced oxygen gas mixture. The reduced oxygen mixture may have 10% oxygen or less, may have 5% oxygen or less, and may have 1% oxygen, and may be mixed with another gas, such as nitrogen. In an embodiment, oxygen is removed from the cavity 222 by the one or more pumps 242, and liquid that controls the temperature to an optimal level is injected into the cavity 222 by the one or more pumps 242. An example of a suitable liquid is liquid carbon dioxide or liquid nitrogen. In another embodiment, a controllable vacuum is applied to the cavity 222 by the one or more pumps 242 to cause evacuation of air within the cavity 222. In another embodiment, a positive pressure is provided in space by the one or more pumps 242.

In another embodiment, the microbial treatment apparatus 240 deters the growth of microbes on the food product 24 by causing antimicrobial agent to come into contact with the food product 24. In an embodiment, the antimicrobial agent of the microbial treatment apparatus 240 is an antimicrobial solution which is deposited onto the food product 24 as the food product 24 is being processed downstream of the entrance product interlock 34. This antimicrobial solution may be deposited by sprayers which dispense the antimicrobial solution onto the food product 24 as it is being processed downstream of the entrance product interlock 34. Suitable antimicrobial solutions include, but are not limited to, alcohols and organic acids such as lactic acid, citric, acetic, peroxyacetic. In yet another embodiment, the antimicrobial agent of the microbial treatment apparatus 240 is light, such as ultraviolet light, emitted from illumination devices which irradiate the food product 24 as it is being processed downstream of the entrance product interlock 34. Other means for deterring the growth of the microbes on the food product 24 are known and are within the scope of the present disclosure. In other embodiments, combinations of sprayers, illuminations devices, etc., can be included in the microbial treatment apparatus 240.

In other embodiments, combinations of one or more of the above microbial treatment apparatuses 240 can be provided.

The processor 204 is in communication with the microbial treatment apparatus 240 for causing actuation of the components of the microbial treatment apparatus 240.

The amount of antimicrobial agent 60 to be applied on the food product 22 can be determined in a variety of manners. In some embodiments, information from a weighing device is communicated to the control system 200 and the processor 204 uses this information to determine the amount of antimicrobial agent 60 to be applied on the food product 22.

In an embodiment, one or more user interface(s) 248 are provided on the exterior of the enclosure 52 and are in communication with the processor 204 and/or memory 206, and/or driving assemblies 178, 180, 182, 184, 186, 188, 190. The operator may input information regarding the food product 22, or regarding parameters on the slicing etc. performed by the assembly 20. The user interface(s) 248 may include any user interface element that may enable an operator to input information. By way of non-limiting example, the user interface(s) 248 may include one or more buttons, one or more switches, a keypad/keyboard, a display, a touch screen display, some combination thereof, or the like. The driving assemblies 178, 180, 182, 184, 186, 188, 190 may be configured to access (e.g., from memory 206) a table or other structure which stores various profiles based on parameters. In an embodiment, the operator inputs information regarding the food product 22 and the processor 204 uses this information to determine the amount of antimicrobial agent 60 to be applied on a given amount of food product 22. In some embodiments, a set amount of antimicrobial agent 60 is always applied by the control system 200 to each food product 22 being processed.

The components of the control system 200 may be housed in a cabinet(s) 250 outside of the enclosure 52.

An operator entrance 252 is provided through one of the walls (shown as wall 218). The operator entrance 252 is sealed to the wall 218 by a seal 254 to prevent the entrance of outside atmosphere into the enclosure 52 through the joint between the operator entrance 252 and the wall 218. The seal 254 may be formed of an elastomeric material, such as urethane. Alternatively, instead of providing a separate seal 254, the components can be welded together to prevent the entrance of atmosphere at the joint.

The operator entrance 252 has first and second doors 256, 258 which are separated from each other by a space 260. Only one door 256, 258 can be opened at a time.

In an embodiment, the entrance product interlock 34 takes the form of the exit product interlock 44. In an embodiment, the exit product interlock 44 takes the form of the entrance product interlock 34. In an embodiment, the entrance product interlock 34 and the exit product interlock 44 take the same form. One benefit to having the exit product interlock 44 as a multi-sided housing is that the packaged food product can be moved out of the enclosure 52 more quickly than using a conventional conveyor belt.

Many modifications and other embodiments of the disclosure set forth herein will come to mind to one skilled in the art to which these disclosed embodiments pertain having the benefit of the teachings presented in the foregoing descriptions and the associated drawings. Therefore, it is to be understood that the disclosure is not to be limited to the specific embodiments disclosed herein and that modifications and other embodiments are intended to be included within the scope of the disclosure. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the disclosure. In this regard, for example, different combinations of elements and/or functions than those explicitly described above are also contemplated within the scope of the disclosure. Although specific terms are employed herein, they are used in a generic and descriptive sense only and not for purposes of limitation.

While particular embodiments are illustrated in and described with respect to the drawings, it is envisioned that those skilled in the art may devise various modifications without departing from the spirit and scope of the appended claims. It will therefore be appreciated that the scope of the disclosure and the appended claims is not limited to the specific embodiments illustrated in and discussed with respect to the drawings and that modifications and other embodiments are intended to be included within the scope of the disclosure and appended drawings. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the disclosure and the appended claims.

What is claimed is:

1. An assembly configured for turning a food product into slices of food product, the assembly comprising:
a microbial treatment assembly configured to move the food product along a path, and a microbial intervention apparatus configured to substantially reduce an amount of microbes on an exterior surface of the food product while the food product is traveling along the path;
a slicing machine downstream of the microbial treatment assembly, the slicing machine being configured to slice the food product into slices;
an enclosure in which the slicing machine is positioned, the enclosure being sealed from outside atmosphere; and
a microbial treatment apparatus in communication with the enclosure and configured to deter growth of microbes on the food product.

2. The assembly of claim 1, wherein the microbial treatment assembly deposits an antimicrobial agent on an exterior surface of the food product.

3. The assembly of claim 2, wherein the antimicrobial agent is one of an acid and ultraviolet light.

4. The assembly of claim 1, wherein the microbial treatment assembly provides a bath of antimicrobial agent through which the food product is moved.

5. The assembly of claim 1, wherein the microbial treatment apparatus modifies an atmosphere of the enclosure.

6. The assembly of claim 5, wherein the atmosphere is modified by one of removing oxygen from the enclosure, providing positive pressure in the enclosure, and applying a vacuum which forms a vacuum in the enclosure.

7. The assembly of claim 5, wherein the atmosphere is modified by one or more pumps that remove oxygen from the enclosure and inject a non-oxygen gas or reduced oxygen gas into the enclosure that promotes shelf life of a food product.

8. The assembly of claim 7, wherein the non-oxygen gas is one of carbon dioxide gas and nitrogen.

9. The assembly of claim 7, wherein the reduced oxygen gas has 10% or less oxygen.

10. The assembly of claim 1, wherein the microbial treatment apparatus deposits an antimicrobial agent on the food product.

11. The assembly of claim 10, wherein the antimicrobial agent is one of an acid and ultraviolet light.

12. The assembly of claim 10, wherein the antimicrobial agent is sprayed within the enclosure by at least one sprayer.

13. The assembly of claim 1, further comprising a peeling machine configured to remove a casing from the food product, the peeling machine being positioned within the enclosure and upstream of the slicing machine.

14. The assembly of claim 1, further comprising a packaging machine configured to package slices received from the slicing machine, the packaging machine being positioned within the enclosure and downstream of the slicing machine.

15. The assembly of claim 1, further comprising an entrance product interlock through which the food product passes without allowing a substantial amount of atmosphere outside of the enclosure to enter into the enclosure.

16. The assembly of claim 15, wherein the entrance product interlock comprises a conveyor within a housing having openable doors at ends of the conveyor.

17. The assembly of claim 15, further comprising an exit product interlock downstream of the slicing machine through which the sliced food product passes without allowing a substantial amount of atmosphere outside of the enclosure to enter into the enclosure.

18. The assembly of claim 17, wherein the exit product interlock comprises a rotatable housing, the housing having a plurality of separated spaces defined by walls of the housing, each space having an openable door.

19. The assembly of claim 1, further comprising an exit product interlock downstream of the slicing machine through which the sliced food product passes without allowing a substantial amount of atmosphere outside of the enclosure to enter into the enclosure.

20. The assembly of claim 1, wherein the enclosure comprises a plurality of walls, one of the walls having an entrance door therethrough.
